(19) United States
(12) Patent Application Publication
(10) Pub. No.: US 2008/0245462 A1
(43) Pub. Date: Oct. 9, 2008

(54) Method of making add-on armor

(75) Inventors: Christoph Huber, Vienna (AT); Karl Skrivanek, Vienna (AT); Johannes Lausch, Gramatneuseidl (AT); Thomas Pawlick, Vienna (AT)

Correspondence Address: K.F. ROSS P.C., 5683 RIVERDALE AVENUE, SUITE 203 BOX 900, BRONX, NY, 10471-0900, US

(73) Assignee: STEYR-DAIMLER-PUCH SPEZIALFAHRZEUG GmbH

(21) Appl. No.: 12/004,426

(22) Filed: Dec. 20, 2007

(30) Foreign Application Priority Data
Dec. 21, 2006 (AU) A2105/2006

(51) Int. Cl. B32B 37/00

(52) U.S. Cl. 156/62.2

(57) ABSTRACT

An add-on armor plate is made by powder coating a thin elastomeric layer at least on edges of a plurality of substantially identical ceramic elements. Then the elements together with their elastomer-coated edges engaging one another. Finally the fitted-together elements are sandwiched between a base sheet and a cover sheet.

### FIELD OF THE INVENTION

The present invention relates to add-on armor. More particularly this invention concerns the manufacture of ceramic add-on armor plating.

### BACKGROUND OF THE INVENTION

Modern add-on armor for armored vehicles must meet very stringent ballistic requirements. The additionally applied protective shell for the vehicles is made up of individual add-on armor elements that are each separately mounted on the vehicle structure. The individual add-on armor elements are designed to be as large as possible, since any gap at the outer edge of an element represents a weak spot in the armor. Typically the elements are precisely matched to the vehicle structure, and in particular the size is selected so that the elements may still be installed manually.

Due to its great hardness and low porosity, a ceramic material such as boron carbide, silicon carbide, aluminum oxide, 20 or the like is frequently used as a ballistic protective material in add-on armor. These ceramics are very hard but also very brittle, so that after the first impact the ceramic element usually is shattered into bits and is not able to withstand a second impact. In order to withstand multiple strikes, the add-on armor is made up of numerous small ceramic elements that are smaller than the smallest assumed shot distance spacing for which the add-on armor is to remain effective. These sections are either embedded in a matrix made of another protective material, or the ceramic elements are shaped in such a way that when positioned adjacent one another they are able to completely cover a surface. In one simple design this may be achieved, for example, by use of regular polygons, for example triangles or squares, or also more complicated interlocking shapes such as those described for example in German patent document 3,716,055.

Great care must be taken in the installation of these individual ceramic elements. When they are too far apart on the support plate there is a risk of a ballistic hole, since as a result of the excessively large gap the supporting effect of the adjacent ceramic element and thus the protective function is no lost. Thus withstanding an impacting projectile may no longer be possible. On the other hand, if the individual ceramic elements directly abut one another, upon impact of a projectile on a ceramic element the shock wave may be transmitted in an undamped manner to the adjacent elements, which due to the high degree of brittleness of the ceramic protective materials are then subject to fracture. It is therefore necessary to trade off close spacing that leaves no gaps for shots to pass with wide spacing that prevents the shattering of one element to cause adjacent elements to be similarly destroyed.

French patent 1,599,798 describes a process for making ceramic add-on armor in which the individual ceramic protective elements, which are shaped as regular polygons, are pressed into an elastomeric substrata to insulate adjacent elements from one another. This method is very difficult to carry out in practice, since each individual element must be positioned very precisely.

Alternately as described in above-cited German 3,716,055, the nested ceramic elements can be of complex shape like puzzle pieces. The space between the individual elements being filled with an elastomer. Production of such armor is also very difficult, since the elements shrink considerably when fired and a high reject level must be taken into account in order to maintain precise gap dimensions. On the other hand, if greater tolerances and thus larger gaps are allowed for penetration of the polymer into the gaps, there is a risk of undesired ballistic gaps.

### OBJECTS OF THE INVENTION

It is therefore an object of the present invention to provide an improved method of making add-on armor.

Another object is the provision of such an improved method of making add-on armor that overcomes the above-given disadvantages, in particular that prevents shock waves from passing between adjacent elements and also ensures the correct spacing between the individual ceramic elements.

### SUMMARY OF THE INVENTION

An add-on armor plate is made according to the invention by powder coating a thin elastomeric layer at least on edges of a plurality of substantially identical ceramic elements. Then the elements together with their elastomer-coated edges engaging one another. Finally the fitted-together elements are sandwiched between a base sheet and a cover sheet.

With this system the powder coating produces a cushion layer that is very thin but of very accurate dimensions so the ceramic elements can be fitted closely together. In spite of this close juxtaposition, however, an impact from a projectile that strikes one element will not be transmitted efficiently to the adjacent elements because of the intervening elastic layer and will therefore not break the adjacent elements.

According to the invention before powder coating the elements the ceramic elements are rendered conductive. The powder coating is then applied electrostatically.

It is also possible, before powder coating the elements to heat them so that the powder melts.

### BRIEF DESCRIPTION OF THE DRAWING

The above and other objects, features, and advantages will become more readily apparent from the following description, reference being made to the accompanying drawing in which:

FIGS. 1, 2, and 3 are plan views of three different add-on armor plates having triangular, square, and hexagonal ceramic elements, respectively; and

FIG. 4 is a cross section through the plate of FIG. 1.

### SPECIFIC DESCRIPTION

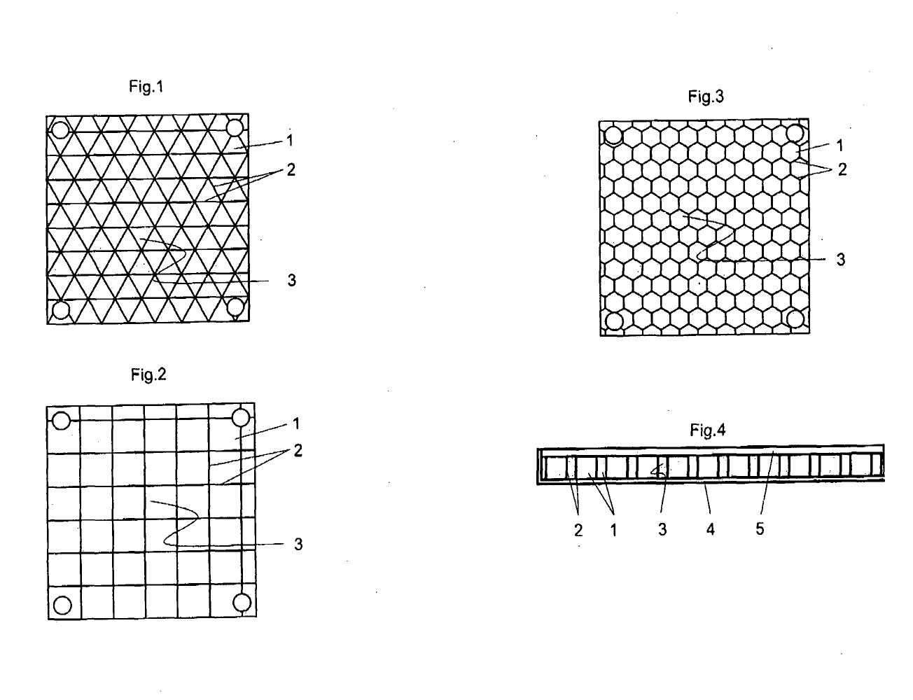

Square plates of add-on armor are made up of triangular ceramic elements 1 (FIG. 1), square elements la (FIG. 2), or hexagonal elements 1b (FIG. 3) that are all identical at least inward of the outer edges of the respective plate and that fit snugly together in a normally planar array. Below the invention is discussed with reference to the FIG. 1 embodiment, it being understood that this discussion applies to the embodiments of FIGS. 2 and 3 with differently shaped elements, and that other shapes are usable so long as the ceramic elements can fit snugly together.

According to the invention the individual ceramic elements 1 are provided at least on their laterally abutting edges with a lacquer coating 2. In one preferred embodiment this lacquer coating 2 is applied using a powder-coating process. In such a process, the body to be coated is usually electrostatically charged, and powder coating that is oppositely charged is sprayed over the body and adheres due to the electrical attraction of the differing electrical charges of the components. The layer thickness of the powder coating may thus be controlled very precisely. The powder coating is then thermally fixed.

Since ceramic is not electrically conductive, it must be pretreated in an appropriate manner. A suitable methods is described, for example, in EP 0963795 and in DE 4417172 where a conductive layer with a low boiling temperature is applied before the element is charged and powder coated, then this conductive layer is cooked off when the powder is heated.

As an alternative to electrostatic charging, the ceramic element to be coated by use of a powder coating may be heated to a temperature above the melting point of the powder coating. In the powder coating process the coating particles adhere to the surface. However, this process has the disadvantage that the layer thickness cannot be controlled as precisely as with electrostatic charging.

Powder coating exists in various qualities which are distinguished by their elastic properties. For a suitable selection, a powder coating 2 may be used that has properties that are elastomeric and are best suited for insulating the transmission of shock waves between the individual ceramic elements 1.

The ceramic elements 1 that are normally completely coated with this powder coating 2 may be placed adjacent one another with a minimal expenditure of effort and, as illustrated in FIG. 4, in a conventional manner may be further processed to produce an add-on armor plate 3 by bonding the ceramic elements 1 to a base plate 4 and overlying them with a protective cover 5. Precise positioning is not necessary, since the individual ceramic elements 1 are simply pushed together and the exact distance is ensured by the thin powder coating 2 of uniform thickness.

We claim:

1. A method of making an add-on armor plate, the method comprising the steps of:
powder coating a thin elastomeric layer on edges of a plurality of substantially identical ceramic elements;
fitting the elements together with their elastomer-coated edges engaging one another; and
sandwiching the fitted-together elements between a base sheet and a cover sheet.

2. The method defined in claim 1 further comprising the step before powder coating the elements of:
rendering the ceramic elements conductive, the powder coating being applied electrostatically.

3. The method defined in claim 1 further comprising the step before powder coating the elements of:
heating the elements.

4. The method defined in claim 1 wherein the elements are polygonal.
